(19) United States
(12) Patent Application Publication
(10) Pub. No.: US 2009/0197430 A1
(43) Pub. Date: Aug. 6, 2009

(54) CONNECTOR

(75) Inventors: Yi Bin LEE, Taoyuan County (TW); Chih Tse CHEN, Taoyuan County (TW); Chen Jung CHEN, Taoyuan County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DELTA ELECTRONICS, INC.

(21) Appl. No.: 12/192,354

(22) Filed: Aug. 15, 2008

(30) Foreign Application Priority Data
Feb. 5, 2008 (TW) 097104476

(51) Int. Cl. H01R 12/00

(52) U.S. Cl. 439/56

(57) ABSTRACT

The invention discloses a connector including a housing, a terminal, a circuit board, and a light-emitting device. The housing has an accommodation space. The terminal is disposed in the accommodation space for being coupled with a plug. The circuit board is disposed in the accommodation space and includes a first surface toward to the terminal and a second surface opposite to the first surface. The light-emitting device is disposed to the first surface.

### CROSS REFERENCE TO RELATED APPLICATIONS

This Non-provisional application claims priority under 35 U.S.C. §119(a) on Patent Application No(s). 097104476 filed in Taiwan, Republic of China on Feb. 5, 2008, the entire contents of which are hereby incorporated by reference.

### BACKGROUND OF THE INVENTION

1. Field of the Invention

The invention relates to a connector, and in particular relates to a connector capable of reducing the interior electro-magnetic interference (EMI).

2. Description of the Prior Art

A conventional connector is generally installed with a situation lamp if a user wants to know the present working situation of the conventional connector. For example, if a network line is inserted into a RJ-45 connector, the lighting of the situation lamp refers to a correction connection between the inserted network line and the connector, and the twinkling of the situation lamp refers to a signal transmission between the network line and the connector. In addition, in order to stabilize the signal received by the connector, the connector can be configured with a filtering coil. The noise of the received signal is filtered out by the filtering coil, and then the filtered signal is transmitted to the processing unit to be processed.

In the prior art, when the situation lamp lights, the interior electrical devices of the connector such as filtering coils will be interfered by the electro-magnetic interference (EMI) generated by the electrode pin with a current. Further, the working efficiency of the filtering coil will be lowered.

### SUMMARY OF THE INVENTION

A connector utilizing a circuit board to shield the EMI generated by the light-emitting device is provided.

The present invention discloses a connector including a housing, a terminal, a circuit board, and a light-emitting device. The housing includes an accommodation space. The terminal is disposed in the accommodation space for being coupled with a plug. The circuit board is disposed in the accommodation space and behind the terminal. The circuit board includes a first surface toward to the terminal and a second surface opposite to the first surface. The light-emitting device is disposed on the first surface and includes a wire. The wire extends along the second surface and passes through the circuit board.

Accordingly, the EMI generated by the light-emitting device can be shielded by the circuit board, and the working efficiency of the connector can be further improved.

In addition, a circuit is formed on the circuit board, and provides the electrical connection between the light-emitting device and other devices. Besides, the circuit board further includes at least one shielding layer for shielding the EMI between the light-emitting device and the terminal. The shielding layer can be formed on the first of second surface of the circuit board. The shielding layer includes conductive material and is electrically connected to the housing. The connector further includes at least one electrical device disposed in the accommodation space, and the electrical device is electrically connected to the terminal.

As a result, since the connector of the present invention utilizes the circuit board and even the shielding layer to shield the path of the current of the light-emitting device, the EMI between the light-emitting device and the terminal and interior electrical device can be reduced to improve the working efficiency of the connector. The advantage and spirit of the invention may be understood by the following recitations together with the appended drawings.

### BRIEF DESCRIPTION OF THE APPENDED DRAWINGS

The present invention will become more fully understood from the detailed description given herein below and the accompanying drawings which are given by way of illustration only, and thus are not limitative of the present invention, and wherein:

FIG. 1 is a cross-sectional view of a connector according to an embodiment of the present invention.

### DETAILED DESCRIPTION OF THE INVENTION

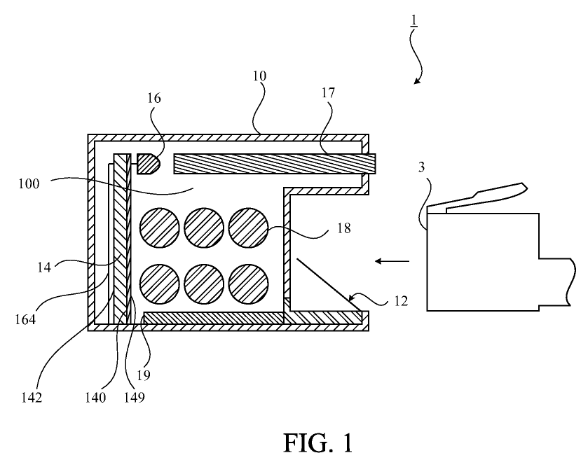

As shown in FIG. 1, a connector 1 includes a housing 10, a terminal 12, a circuit board 14, a light-emitting device 16, and a light-guiding member 17. The housing 10 includes an accommodation space 100. The terminal 12 is disposed in the accommodation space 100 for being coupled with a plug 3. The circuit board 14 is disposed in the accommodation space 100 and behind the terminal 12. The circuit board 14 includes a first surface 140 toward to the terminal 12 and a second surface 142 opposite to the first surface 140. The light-emitting device 16 is disposed on the first surface 140.

The light-emitting device 16 can be a LED or other semiconductor light-emitting device such as laser diode. The light-emitting device 16 can emit the monochromatic or multi-color light according to different signals. The light-emitting device 16 includes a wire 164 extending along the second surface 142 of the circuit board 14. Specifically, the wire 164 can be disposed to cross the side edge of the circuit board 14 and pass through the circuit board 14. Moreover, the wire 164 can be electrically connected to a solder pad (not shown in the drawing) of the circuit board 14 and extended along the second surface 142 of the circuit board 14.

A circuit connected to the light-emitting device 16 can be directly disposed on the circuit board 14, and the wire 164 can be replaced with the circuit. Further, the light-emitting device 16 can be electrically connected to the circuit via a hole or a solder pad. In addition, the circuit can be disposed on the second surface 142 of the circuit board 14 or even inside the circuit board 14.

Since the circuit board 14 has a function to shield the EMI, the connector 1 can utilize the circuit board 14 to shield the EMI between the light-emitting device 16 and the terminal 12.

In addition, in order to improve the shielding efficiency, the circuit board 14 further includes a shielding layer 149 to shield the EMI between the light-emitting device 16 and the terminal 12. The shielding layer 149 can be formed on the first surface 140, on the second surface 142, or inside the circuit board 14. The shielding layer 149 includes conductive material. When the housing 10 has a conductive part, the shielding layer 149 can be electrically connected to the conductive part of the housing 10 so that the shielding layer 149 can ground via the conductive part.

The terminal 12 can also be a RJ-45, RJ-11, or USB terminal. Additionally, the connector 1 further includes at least one electrical device 18 disposed in the accommodation space 100 and electrically connected to the terminal 12. The electrical device 18 can be a transformer, an inductor, a resistor, or a filter for processing the electrical signal received from or transmitted to the terminal 12.

In addition, the connector further includes a main circuit board 19 electrically connected to the terminal 12 and/or the circuit board 14. If the user wants to modify the electrical connection among the interior components of the connector 1, the user only needs to modify the circuit disposed on the main circuit board 19 or replace the circuit board 19 without the needs of changing the positions of components.

In addition, the connector 1 further includes a light-guiding member 17 correspondingly disposed with the light-emitting device 16. The light-guiding member 17 can guide the light emitted from the light-emitting device 16 out of the housing 10. The light-emitting device 16 can emit the monochromatic or multi-color light according to different signals. The light-guiding member 17 is a light pipe in the shape of column, L-shape, indentation, or waviness.

As a result, because a circuit board exists between the path of the current of the light-emitting device (alternatively, the wire or the circuit of the circuit board) and the terminal, the EMI between the light-emitting device and the terminal and interior electrical device can be effectively shielded. Further, a shielding layer is disposed on the circuit board to raise the shielding efficiency of the circuit board.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A connector comprising:
a housing having an accommodation space;
a terminal disposed in the accommodation space to be coupled with an plug;
a circuit board disposed in the accommodation space and having a first surface; and
a light-emitting device disposed on the first surface.

2. The connector of claim 1, wherein the circuit board comprises a circuit electrically connected to the light-emitting device.

3. The connector of claim 2, wherein the circuit board has at least one hole for enabling a wire of the light-emitting device to pass through the hole to be electrically connected to the circuit.

4. The connector of claim 2, wherein the circuit board comprises at least one solder pad, and the light-emitting device is electrically connected to the circuit via the solder pad.

5. The connector of claim 2, wherein the circuit is disposed on a second surface opposite to the first surface of the circuit board or inside the circuit board.

6. The connector of claim 1, wherein the light-emitting device comprises a wire extended along the second surface of the circuit board.

7. The connector of claim 6, wherein the wire is electrically connected to the light-emitting device via a hole or a solder pad of the circuit board.

8. The connector of claim 1, wherein the circuit board comprises at least one shield layer for preventing interference between the light-emitting device and the terminal.

9. The connector of claim 8, wherein the shield layer is disposed on the first surface or a second surface of the circuit board, or inside the circuit board.

10. The connector of claim 8, wherein the shield layer comprises a conductive material.

11. The connector of claim 8, wherein the shield layer is electrically connected to the housing.

12. The connector of claim 1, wherein the terminal is a RJ-45, RJ-11, or USB terminal.

13. The connector of claim 1, further comprising at least one electrical device disposed in the accommodation space and electrically connected to the terminal.

14. The connector of claim 13, wherein the electrical device is a transformer, inductor, resistor, or filter.

15. The connector of claim 1, wherein the light-emitting device is a light emitting diode or laser diode.

16. The connector of claim 1, wherein the light-emitting device emits a monochromatic or multi-color light.

17. The connector of claim 1, further comprising a main circuit board electrically connected to the terminal and/or the circuit board.

18. The connector of claim 1, further comprising a light-guiding member for guiding a light emitted from the light-emitting device.

19. The connector of claim 18, wherein the light-guiding member is a light pipe in the shape of column, L-shape, indentation, or waviness.
